(19) United States
(12) Patent Application Publication
(10) Pub. No.: US 2002/0195992 A1
(43) Pub. Date: Dec. 26, 2002

(54) Rechargeable battery

(76) Inventors: Yung-Tang Lee, Taipei (TW); Shih-Min Wang, Taipei (TW)

Correspondence Address: BIRCH STEWART KOLASCH & BIRCH, PO BOX 747, FALLS CHURCH, VA, 22040-0747, US

(21) Appl. No.: 09/885,933

(22) Filed: Jun. 22, 2001

(51) Int. Cl. H02J 7/00

(52) U.S. Cl. 320/112

(57) ABSTRACT

A rechargeable battery applicable to an electronic device according to the invention includes a first power-storage portion and a second power-storage portion for storing electrical power respectively. Generally, only the first power-storage portion is connected to the electronic device for supplying power, and will be replaced or recharged if already exhausted. The second power-storage portion is for emergency or temporary use when a supplementary battery or a recharger is not available.

### BACKGROUND OF THE INVENTION

1. Field of Invention

The present invention generally relates to a rechargeable battery, and more particularly relates to a rechargeable battery applicable to an electronic device, such as a mobile phone, personal digital assistant or digital camera, in which backup power is included for temporary or emergency use.

2. Related Art

Electronic devices, such as mobile phones or personal digital assistants, are indispensable tools in people's modern lives. Mobile phones help personal remote communications, while PDAs help people store, manage and process information. Other electronic products, such as Walkmans, digital cameras and notebook computers, also help people create faster, more convenient and more comfortable living conditions. However, these devices require electrical power. They lose their function if there is no power supply. Portable electronic devices are usually powered by batteries. Among different kinds of batteries, rechargeable batteries are the most popular. When the rechargeable battery is exhausted, it can be recharged and repeatedly reused. Rechargeable batteries are also called secondary batteries.

For example, mobile phones are generally powered by rechargeable batteries. When the power is exhausted, the battery has to be recharged before reusing. Recharging is done through a recharging device. Two kinds of recharging devices are commonly used. A mobile recharger is suitable for use when travelling, as the recharging connector of the mobile phone can be linked to the recharger for recharging the battery. A desktop recharger has larger dimensions, is suitable for use at home, and the recharging can be performed with the battery in the mobile phone or on the battery alone. The recharging instructions generally recommend that the rechargeable battery be recharged only when totally exhausted, so as to lengthen the life of the battery. Therefore, users are accustomed to using up a battery before replacing or recharging it. To avoid the situation of having no power supply for the mobile phone, a supplementary battery has to be prepared. If no supplementary battery is brought or no recharger is prepared, then the electronic device cannot work at all.

### SUMMARY OF THE INVENTION

The object of the invention is therefore to provide a rechargeable battery that has backup power built-in, so as to provide backup power when a main power is exhausted.

To achieve the aforesaid object, a rechargeable battery according to the invention includes a first power-storage portion and a second power-storage portion for storing electrical power respectively. Generally, only the first power-storage portion is connected to the electronic device for supplying power, and will be replaced or recharged if already exhausted. The second power-storage portion is for emergency or temporary use when a supplementary battery is not available.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description provided below. However, this description is for purposes of illustration only, and thus is not limitative of the present invention, wherein:

FIG. 1 is a perspective view of a first embodiment of the invention;

FIG. 2 is a plane view of the first embodiment of the invention;

FIG. 3A is a use condition of the first embodiment of the invention;

FIG. 3B is another use condition of the first embodiment of the invention;

FIG. 4A is a perspective view of a second embodiment of the invention;

FIG. 4B is another perspective view of the second embodiment of the invention taken from a different angle; and

FIG. 4C is a plane view of the second embodiment of the invention.

### DETAILED DESCRIPTION OF THE INVENTION

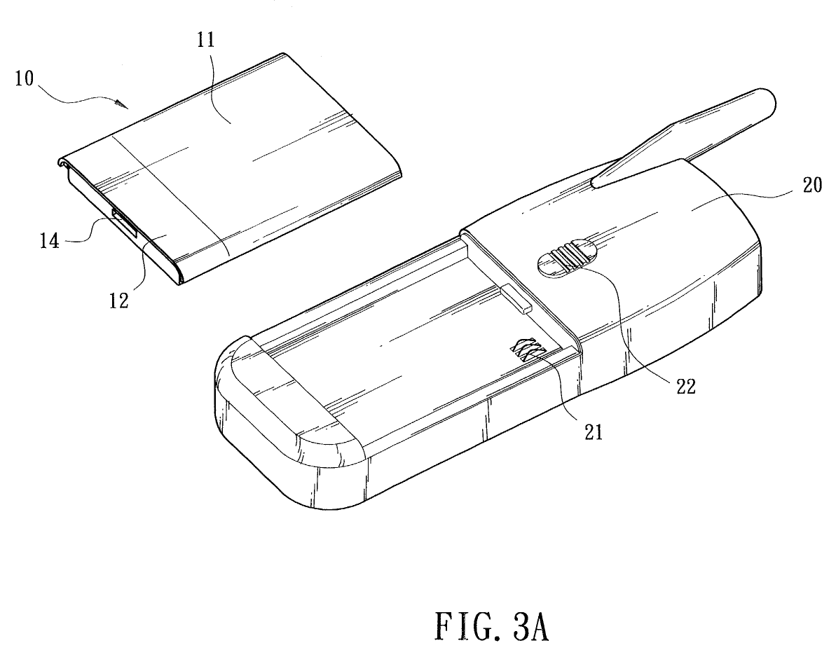

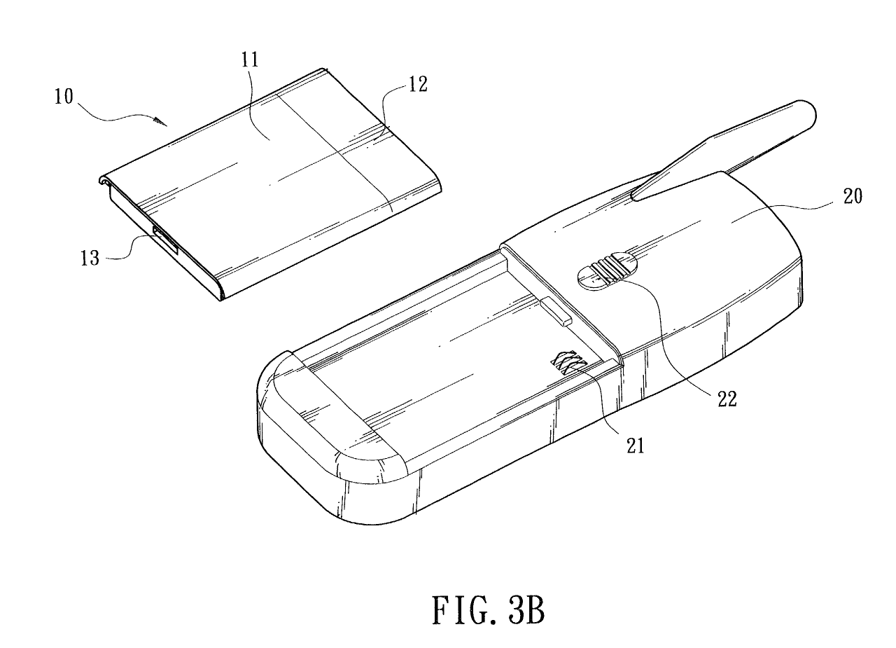

The invention provides a rechargeable battery 10 applicable to an electronic device 20, such as mobile phone (as shown in FIG. 3A), a personal digital assistant, a Walkman, a digital camera or a notebook computer, for supplying electrical power. The rechargeable battery 10 is selectively installed on the electronic device 20 for supplying power, and detached from the electronic device 20 for being replaced or recharged.

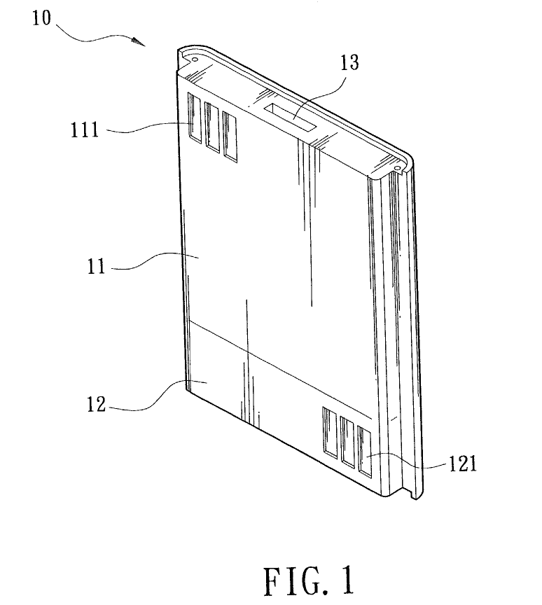

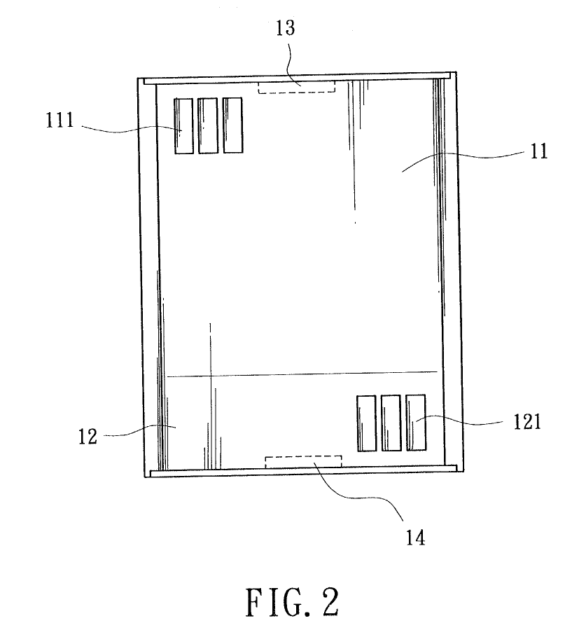

As shown in FIGS. 1 and 2, a rechargeable battery 10 according to the invention includes a first energy-storage portion 11 and a second energy-storage portion 12. The rechargeable battery is generally made of nickel-hydrogen or lithium, having electrodes of nickel or lithium. The composition and process of the rechargeable battery are of prior arts that will not be described in detail herein. The first and second energy-storage portions are independent battery cells that have different energy capacities. The shell of the rechargeable battery 10 holds the two portions 11, 12 as a unit. As shown in the drawings, the two portions 11, 12 are located on the upper and a lower portion of the battery 10. The first energy-storage portion 11 has a volume of three fourths of the whole battery 10, while the second energy-storage portion 12 has a volume of one fourth thereof. Therefore, the first energy-storage portion 11 has a larger energy capacity than the second energy-storage portion 12.

There are first connecting points 111 and second connecting points 121 formed on the first and second energy-storage portions 11, 12 respectively. The rechargeable battery 10 is symmetrical in shape and can be installed in the electronic device 20 in two different directions. The first connecting points 111 and the second connecting points 121 are also symmetrically located, so that one of them will connect with the electronic device 20 when the battery 10 is installed. Two grooves 13, 14 are formed on opposite sides of the battery 10 for a latch 22 of the electronic device 20 to fit in.

As shown in FIGS. 3A and 3B, the battery 10 is normally installed in the electronic device 20 with the first connecting points 111 of the first energy-storage portion 11 connecting to the electrodes 21 of the electronic device 20. Therefore, only the first energy-storage portion 11 supplies power. When the first energy-storage portion 11 is exhausted, the battery 10 can be replaced or recharged. If there is no recharger or supplementary battery available, then the second energy-storage portion 12 can be temporally used. In this embodiment, the rechargeable battery 10 can be reinstalled upside-down to make the second connecting points 121 of the second energy-storage portion 12 connect to the electronic device 20, so as to supply power from the second energy-storage portion 12.

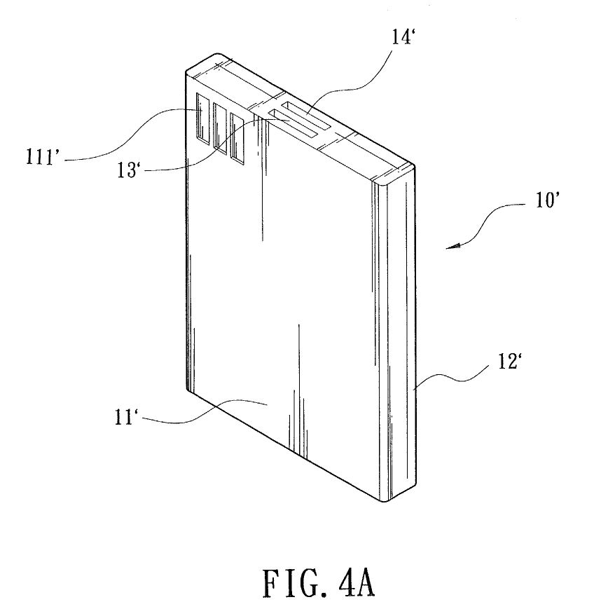

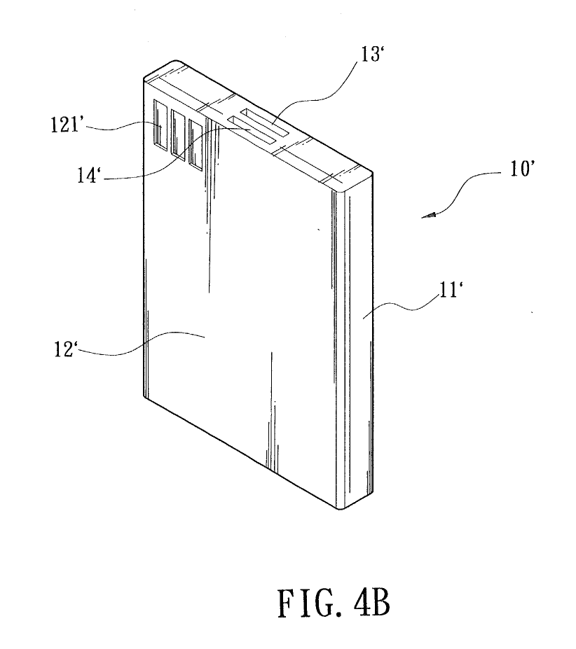

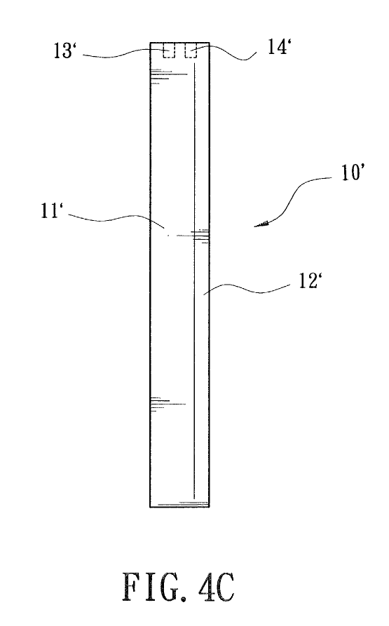

FIGS. 4A, 4B and 4C illustrate a second embodiment of the invention. The rechargeable battery 10′ includes a first and a second energy-storage portion 11′ and 12′ located on opposite sides of the battery 10′. There are also first connecting points 111′ and second connecting points 121′ formed on the first and second energy-storage portions 11′, 12′ respectively. The rechargeable battery 10′ is symmetrical in shape and can be installed in the electronic device 20 in two different directions. The first connecting points 111′ and the second connecting points 121′ are also symmetrically located, so that one of them will connect with the electronic device 20 when the battery 10′ is installed. Two grooves 13′ and 14′ are formed on top of the battery 10′ for a latch 22 of the electronic device 20 to fit in.

As shown in the drawings, the battery 10′ is normally installed in the electronic device 20 with the first connecting point 111′ of the first energy-storage portion 11′ connecting to the electronic device 20. Therefore, only the first energy-storage portion 11′ supplies power. When the first energy-storage portion 11′ is exhausted , the battery 10′ can be replaced or recharged. If there is no recharger or supplementary battery available, then the second energy-storage portion 12 can be temporally used. In this embodiment, the rechargeable battery 10′ can be reinstalled on its other side to make the second connecting points 12′1 of the second energy-storage portion 12′ connect to the electronic device 20 and supply power from the second energy-storage portion 12′.

As described above, the rechargeable battery of the invention includes a backup power portion that can provide supplementary power for temporary or emergency use. Therefore, it can prevent a sudden shortage of battery power.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rechargeable battery for supplying electrical power to an electronic device, comprising:
a first energy-storage portion, as an independent rechargeable battery cell capable of being repeatedly recharged and used; and
a second energy-storage portion, as an independent rechargeable battery cell capable of being repeatedly recharged and used; said second energy-storage portion is mounted in adjacent to said first energy-storage portion and formed therewith as a unit.

2. A rechargeable battery for supplying electrical power to an electronic device according to claim 1 wherein said electronic device is a mobile phone.

3. A rechargeable battery for supplying electrical power to an electronic device according to claim 1 wherein said electronic device is a personal digital assistant.

4. A rechargeable battery for supplying electrical power to an electronic device according to claim 1 wherein said electronic device is a Walkman.

5. A rechargeable battery for supplying electrical power to an electronic device according to claim 1 wherein said electronic device is a digital camera.

6. A rechargeable battery for supplying electrical power to an electronic device according to claim 1 wherein said electronic device is a notebook computer.

7. A rechargeable battery for supplying electrical power to an electronic device according to claim 1 wherein said first energy-storage portion comprises first electrical connecting points for output of electrical power from said first energy-storage portion.

8. A rechargeable battery for supplying electrical power to an electronic device according to claim 1 wherein said second energy-storage portion comprises second electrical connecting points for output of electrical power from said second energy-storage portion.
